(19) United States
(12) Patent Application Publication
(10) Pub. No.: US 2015/0283037 A1
(43) Pub. Date: Oct. 8, 2015

(54) BOTTLE WITH INTERNAL MIXER

(71) Applicant: Rosa Trejo, Oklahoma City, OK (US)

(72) Inventor: Rosa Trejo, Oklahoma City, OK (US)

(21) Appl. No.: 14/247,749

(22) Filed: Apr. 8, 2014

(51) Int. Cl. A61J 9/00; B01F 3/12; B01F 15/00; B01F 13/00

(52) U.S. Cl. CPC A61J 9/00; B01F 13/0022; B01F 3/1221; B01F 15/00519; B01F 15/00844; B01F 15/0087; B01F 2003/125; B01F 2015/0059; B01F 2215/0022; B01F 2215/0039

(57) ABSTRACT

A bottle with internal mixer comprising a bottle, where the bottle is separated into an upper portion and a lower portion, where the upper portion receives a powdered drink substance and the lower portion receive a liquid; a separator between the upper portion and the lower portion, where the separator is divided into two pieces along a seam; a sliding button coupled to the separator, outside the bottle, where the sliding button separates the separator to create an opening at the seam; a lid fastened to a neck atop the bottle; a mixer attached below the lower portion of the bottle, where the mixer includes a fan to mix the powdered drink substance into the liquid thereby creating a homogenous mixture; and a motor attached to the mixer to power the fan.

### BACKGROUND OF THE INVENTION

1. Field of the Invention

The present invention relates to an infant bottle with an internal mixer to quickly and easily mix baby formula and water without clumps.

2. Description of Related Art

Baby bottles are one of the most common and essential tools used by parents and guardians when caring for a newborn, baby or toddler. The bottles are used to administer nourishment to the infant by utilizing their most innate feeding function of suckling. The bottles may be used to feed breast milk, formula, juice, electrolyte drinks, medications and the like. As the baby grows and develops their motor skills they may transition from using the bottles, to sippy cups, cups with straw and eventually drinking glasses.

Typically, when using formula, a powdered mix is deposited into the bottle with a premeasured amount of water. The powder dissolves into the water as a nutritious beverage for the baby. Often, after adding the formula to the bottle, the parent or care giver must shake and swirl the bottle repeatedly until all of the formula is dissolved. Even after multiple shakes clumps may be visible which in turn clog the nipple and prevent the baby from completing their meal. Additionally, after excessive shaking air bubbles are trapped in the liquid which may cause gas and discomfort for the infant.

Therefore it would be beneficial in the art to provide a baby bottle with a means to eliminate formula clumps. It would also be desirable in the art to provide a baby bottle with a means to dispense the formula into the bottle.

### SUMMARY OF THE INVENTION

In view of the foregoing disadvantages inherent in the prior art, the general purpose of the present invention is to provide a baby bottle with an internal mixer, configured to include all of the advantages of the prior art, and to overcome the drawbacks inherent therein.

Accordingly, an object of the present invention is to provide a baby bottle with an internal mixer to mix and eliminate clumps of formula before feeding a baby.

Another object of the present invention is to provide a bottle with internal mixer that includes a reservoir to house the powdered formula until needed to mix into the bottle.

To achieve the above objects, in an aspect of the present invention, a bottle with internal mixer is described comprising a bottle, where the bottle is separated into an upper portion and a lower portion, where the upper portion receives a powdered drink substance and the lower portion receive a liquid; a separator between the upper portion and the lower portion, where the separator is divided into two pieces along a seam; a sliding button coupled to the separator, outside the bottle, where the sliding button separates the separator to create an opening at the seam; a lid fastened to a neck atop the bottle; a mixer attached below the lower portion of the bottle, where the mixer includes a fan to mix the powdered drink substance into the liquid thereby creating a homogenous mixture; and a motor attached to the mixer to power the fan.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing in which:

FIG. 1 depicts an exploded view of a bottle with internal mixer in accordance with an exemplary embodiment of the present invention.

### DETAILED DESCRIPTION OF THE DRAWINGS

The present invention relates to an infant bottle with an internal mixer to quickly and easily mix baby formula and water without clumps. The present invention provides a bottle with internal mixer to facilitate dissolving formula in the bottle without having to shake the bottle. The bottle with internal mixer includes a bottle with an upper reservoir to hold the formula. Below the reservoir is a mixer to separate and distribute the formula as it falls into the bottle. With the bottle with internal mixer the user is afforded a bottle that efficiently and effectively mixes the powdered formula into water thereby preventing the need to repeatedly shake the bottle when trying to eliminate clumps.

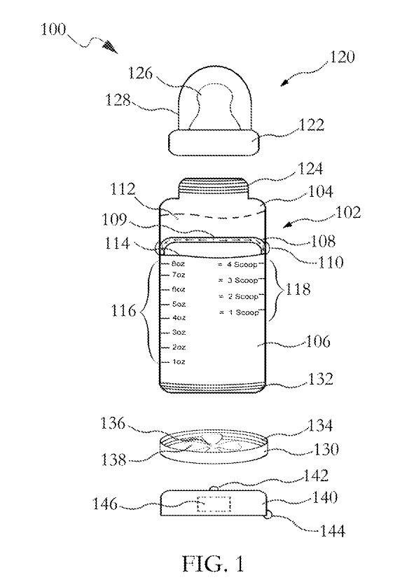

Turning now descriptively to the drawing, referring to FIG. 1, an exploded view of a bottle with internal mixer 100 is shown in accordance with an exemplary embodiment of the present invention. The bottle with internal mixer 100 includes a bottle 102 with a lid 120. As illustrated, the bottle 102 is a baby bottle, but may also be a water bottle, drinking bottle, sports bottle or the like. The bottle 102 is separated into an upper portion 104 and a lower portion 106 which are divided with a separator 108. The separator 108 is divided into two pieces that are joined at a seam 109.

The upper portion 104 serves as a reservoir to receive and contain a powdered a powdered drink substance 112. The powdered drink substance 112 remains in the reservoir 104 until dispensed through the separator 108 into the lower portion 106. The lower portion 106 receives a liquid 114 for consumption, like water, juice, electrolyte drink, carbonated beverage, medications or the like. When the powdered drink substance 112 is dispensed from the upper portion 104 into the lower portion 106 it mixes and dissolves into the liquid 114.

The separator 108 is activated with a sliding button 110. When the sliding button 110 is pressed, the separator 108 separates along a seam 109, which thereby creates an opening through which the powdered drink substance 112 passes. A sliding button 110 may be positioned along each side of the bottle 102 to pull each part of the separator 108. The separator 108 moves away from the seam 109 in the directions of the arrows illustrated.

Along the length of the bottle 102 may be a plurality of volume indicator marks 114. The volume indicator marks 103 inform the user as to the amount of liquid within the bottle 102 for measurement accuracy. Likewise, a plurality of scoop indicator marks 118 may be positioned along the bottle 102. Both marks inform the user as to the amount of beverage within the bottle 102 to feed the baby.

At the upper portion of the bottle 102 is a lid 120. The lid 120 includes a collar 122 that attaches to a threaded neck 124 at the upper portion 104 of the bottle 102. Extending from the collar 122 may be a nipple 126 from where the mixed liquid is dispensed. To protect the nipple 126 and to help prevent spills is a cap 128 that is received into a peripheral edge of the collar 122

Coupled to a bottom of the lower portion 106 is a mixer 130. The mixer 130 is threaded 134 to be removably attached to the lower portion 106. The mixer 130 includes a rotating fan 136 powered by a motor 140. The fan 136 includes a plurality of blades 138 which mix and swirl the powdered drink substance 112 into the liquid 114. The fan 136 and even the blades 138 may be removable from the mixer 130 for washing. The motor 140 includes a fastener 142 upon which the fan 136 is positioned for movement. The motor 140 initiates rotating the fan 136 with an activation button 144. The mixer 120 may be powered with a battery 146 where the battery 146 is a lithium battery, AAA battery or the like. The battery 146 may be rechargeable. The motor 140 is detachable to keep water and other liquids away from the battery 146 while preparing the bottle with internal mixer 100, and to keep the battery 146 away from the baby during consumption.

Easy to use, the user simply fills the bottle 102 with the liquid 114 to the desired volume mark 116. At rest, the separator 108 keeps the powdered drink substance 112 within the upper portion 104. After the sliding button 110 is pressed the separator 108 divides to enable the powdered drink substance 112 to fall into the liquid 114 within the bottle 102. After the powdered drink substance 112 falls through the separator 108 the fan 136 is activated by the activation button 144 to mix with the liquid 114 and powdered drink substance 112 until a homogenous mixture is attained. The user may then press the activation button 144 one last time to stop the fan 136 from turning. With the bottle with internal mixer 100 the user is afforded a product that eliminates having to shake a bottle to mix the powder. The unique design first separates the powder from the liquid, and then serves as a tool to combine the two into a nutritious beverage for the user.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A bottle with internal mixer comprising:
a. a bottle, where the bottle is separated into an upper portion and a lower portion, where the upper portion receives a powdered drink substance and the lower portion receive a liquid;
b. a separator between the upper portion and the lower portion, where the separator is divided into two pieces along a seam;
c. a sliding button coupled to the separator, outside the bottle, where the sliding button separates the separator to create an opening at the seam;
d. a lid fastened to a neck atop the bottle;
e. a mixer attached below the lower portion of the bottle, where the mixer includes a fan to mix the powdered drink substance into the liquid thereby creating a homogenous mixture; and
f. a motor attached to the mixer to power the fan.

2. The bottle with internal mixer according to claim 1, where the bottle is an infant bottle.

3. The bottle with internal mixer according to claim 2, where the lid includes a collar, a nipple, and a cover, where the nipple dispenses the homogenous mixture.

4. The bottle with internal mixer according to claim 1, where the motor is powered with a battery.

5. The bottle with internal mixer according to claim 1, where the motor includes an activation button to initiate rotation of the partition.

6. The bottle with internal mixer according to claim 1, where the motor includes a fastener, where the fastener receives the fan.

7. The bottle with internal mixer according to claim 1, where the motor separates from the mixer.

8. The bottle with internal mixer according to claim 1, where the bottle includes a plurality of volume indicator marks.

9. The bottle with internal mixer according to claim 1, where the bottle is one of at least a water bottle, a drinking bottle, or a sports bottle.

10. The bottle with internal mixer according to claim 1, where the fan is removable.
